(19) United States
(12) Patent Application Publication
(10) Pub. No.: US 2017/0371502 A1
(43) Pub. Date: Dec. 28, 2017

(54) GAZE DETECTION TO PREVENT INADVERTENT KEY GRABBING

(71) Applicant: International Business Machines Corporation, Armonk, NY (US)

(72) Inventors: Ilse M. Breedvelt-Schouten, Manotick (CA); Jana H. Jenkins, Raleigh, NC (US); Jeffrey A. Kusnitz, Campbell, CA (US); John A. Lyons, Ottawa (CA)

(21) Appl. No.: 15/704,036

(22) Filed: Sep. 14, 2017

Related U.S. Application Data
(63) Continuation of application No. 15/078,176, filed on Mar. 23, 2016.

(51) Int. Cl. G06F 3/0481; G06F 3/0484; G06F 3/01

(52) U.S. Cl. CPC G06F 3/0481; G06F 3/013; G06F 3/04842

(57) ABSTRACT

A first input of a user is received in a first window. The first window is active. An indication that a second window is active and the first window is inactive is received. In response to receiving the indication that the second window is active, the first input of the user is directed to the second window from a time that the second window became active. The gaze of the user is determined. In response to determining that the gaze of the user is on the second window, the first input of the user is accepted in the second window from a time the gaze of the user is on the second window.

### BACKGROUND OF THE INVENTION

The present invention relates generally to the field of device input, and more particularly to directing keyboard input to a desired location.

In computing, an input device is a peripheral (i.e., a piece of computer hardware equipment) used to provide data and control signals to an information processing system such as a computer, smartphone, or other information appliance. Examples of input devices include keyboards, a mouse, scanners, digital cameras, and joysticks. A “keyboard” is a human interface device which is represented as a layout of buttons. Each button, or key, can be used to either input a linguistic character to a computer, or to call upon a particular function of the computer. Keyboards act as the main text entry interface for most users. Traditional keyboards use spring-based buttons, though newer variations employ virtual keys, such as with a touch screen, or even projected keyboards. A keyboard is a typewriter like device composed of a matrix of switches.

### SUMMARY

Embodiments of the present invention include a method, computer program product, and system for directing keyboard input to a desired location. In one embodiment, a first input of a user is received in a first window. The first window is active. An indication that a second window is active and the first window is inactive is received. In response to receiving the indication that the second window is active, the first input of the user is directed to the second window from a time that the second window became active. The gaze of the user is determined. In response to determining that the gaze of the user is on the second window, the first input of the user is accepted in the second window from a time the gaze of the user is on the second window.

### BRIEF DESCRIPTION OF THE DRAWINGS

FIG. 1 is a functional block diagram of a computing environment, in accordance with an embodiment of the present invention;

FIG. 2 is a flowchart depicting operational steps of a program that functions to direct keyboard input to a desired location, in accordance with an embodiment of the present invention;

FIG. 3 is an example of two windows displayed in a computer display, in accordance with an embodiment of the present invention; and

FIG. 4 depicts a block diagram of the components of the computing environment of FIG. 1, in accordance with an embodiment of the present invention.

### DETAILED DESCRIPTION

Some embodiments of the present invention recognize that computer input via a keyboard is a simple and repetitive process. One who excels in typing on a keyboard can achieve a speed of upwards of seventy-five words per minute while barely glancing at the computer monitor. A problem may arise if a new dialogue box opens and “grabs” (i.e., keyboard input is directed to the new dialogue box) the keyboard input without the user noticing. For example, a user may be typing a document into a text editor while another window opens requesting the user to restart the computer for an anti-virus update. If the user happens to key the letter ‘Y’ for ‘yes’, the computer may shutdown in preparation of a restart and the user may lose changes to the document that have not been saved. In another example, consider an instant messaging window opening which becomes “active” (i.e., keyboard input is directed to the instant message window). A user may be typing information to a first person which may inadvertently be sent to a second person if the user is not aware of the new, active window that has opened.

Embodiments of the present invention recognize that there may be advantages to directing keyboard input to a desired location. Embodiments of the present invention recognize that there may be advantages to controlling the destination of the keyboard input by the gaze of the user. In addition, erroneous keyboard input may be discarded, rather than accepted, thereby eliminating unintended consequences such as an unwanted computer shutdown resulting in lost data.

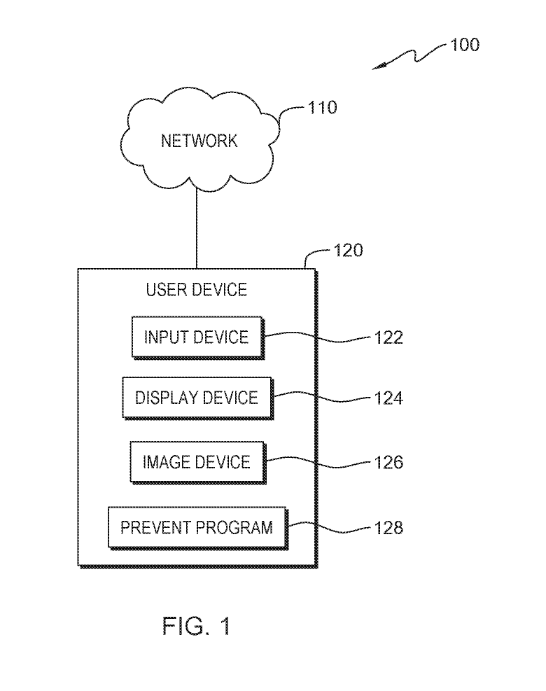

FIG. 1 is a functional block diagram of a computing environment, generally designated 100, in accordance with an embodiment of the present invention. FIG. 1 provides only an illustration of one implementation and does not imply any limitations with regard to the environments in which different embodiments may be implemented. Those skilled in the art may make many modifications to the depicted environment without departing from the scope of the invention as recited by the claims.

An embodiment of computing environment 100 includes user device 120 which includes input device 122, display device 124, image device 126, and prevent program 128. User device 120 is connected to network 110. In example embodiments, computing environment 100 may include other computing devices not shown such as smartwatches, cell phones, smartphones, phablets, tablet computers, laptop computers, desktop computers, other computer servers, or any other computer system known in the art, interconnected with user device 120 over network 110.

In example embodiments, user device 120 may connect to network 110 which enables user device 120 to access other computing devices and/or data not directly stored on user device 120. Network 110 may be a local area network (LAN), a telecommunications network, a wide area network (WAN) such as the Internet, or any combination of the three, and include wired, wireless or fiber optic connections. Network 110 may include one or more wired and/or wireless networks that are capable of receiving and transmitting data, voice, and/or video signals, including multimedia signals that include voice, data, and video information. In general, network 110 may be any combination of connections and protocols that will support communications between user device 120 and other computing devices (not shown) within computing environment 100, in accordance with embodiments of the present invention.

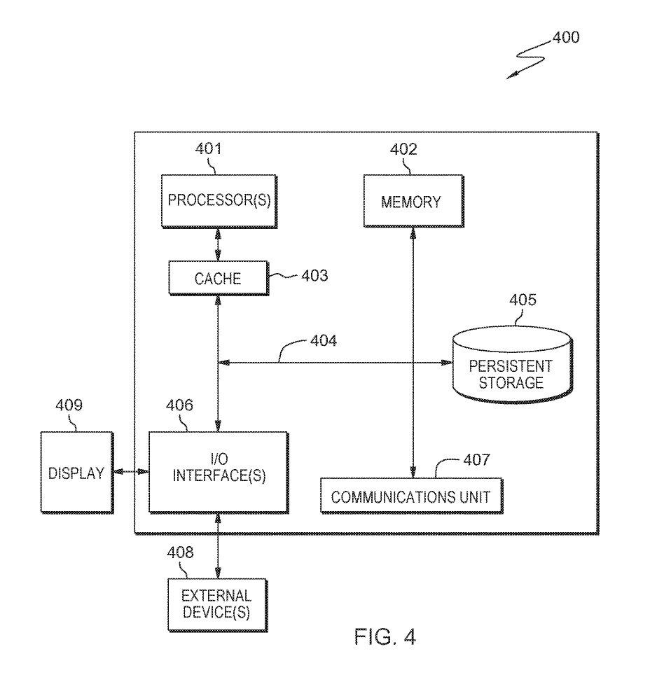

In embodiments of the present invention, user device 120 may be a laptop, tablet, or netbook personal computer (PC), a desktop computer, a personal digital assistant (PDA), a smartphone, or any other hand-held, programmable electronic device capable of communicating with any computing device within computing environment 100. In certain embodiments, user device 120 represents a computer system utilizing clustered computers and components (e.g., database server computers, application server computers, etc.) that act as a single pool of seamless resources when accessed by elements of computing environment 100. In general, user device 120 is representative of any electronic device or combination of electronic devices capable of executing computer readable program instructions. Computing environment 100 may include any number of user device 120. User device 120 may include components as depicted and described in further detail with respect to FIG. 4, in accordance with embodiments of the present invention.

In an embodiment, input device 122 may be a peripheral (i.e., a piece of computer hardware equipment) used to provide data and control signals to an information processing system such as a computer, smartphone, or other information appliance. In an embodiment, input device 122 provides data and control signals to user device 120. According to an embodiment of the present invention, input device 122 is a keyboard. A keyboard is a human interface device which is represented as a layout of buttons. Each button, or key, may be used to either input a linguistic character to a computer, or to call upon a particular function of the computer. Keyboards act as the main text entry interface for most users. In other embodiments, input device 122 may include one or more of the following: a mouse, a joystick, or a microphone for audio input.

In another embodiment, input device 122 may be a touch screen. A touch screen is a technology, used in conjunction with a graphical user interface or GUI (not shown) which allows user device 120 to accept user input. Touch screens are included in many electronic devices such as game consoles, tablet computers, phablets, smartphones, PDAs, and the like. In example embodiments, a touch screen may include the following technologies: resistive; surface acoustic wave; capacitive, including surface capacitance, projected capacitance, mutual capacitance, and self-capacitance; infrared grid; infrared acrylic projection; optical imaging; dispersive signal technology; acoustic pulse recognition; and the like. In one embodiment, a touch screen may include haptic feedback, an example of which is a vibratory response to the touch of the touch screen.

In an embodiment, display device 124 may be an electronic visual display for a desktop computer, laptop computer, tablet computer, smartphone, smartwatch, etc. An electronic visual display may include a touch screen which is an input device layered on top of the display for allowing a user to control an electronic device via simple or multi-touch gestures by touching the display with a special stylus and/or one or more fingers. The display device in modern monitors is typically a thin film transistor liquid crystal display (TFT-LCD) or a flat panel LED (light emitting diode) display, while older monitors used cathode ray tubes (CRT). In an embodiment, display device 124 may be substantially similar to display 409 in FIG. 4, discussed later.

In an embodiment, image device 126 determines the point of gaze of a user of user device 120. In other words, image device 126 determines where the user is looking on display device 124. In one embodiment, image device 126 may be part of a microprojector which transmits an infrared (IR) beam at the eye, and a set of sensors receive the reflection patterns to determine eye position and movement. In another embodiment, image device 126 may be a video camera which receives the reflection patterns from the eye. Video based eye trackers may track corneal reflection and the center of the pupil of the eye, may track reflections from the front of the cornea of the eye and the back of the lens of the eye, or may track features inside the eye, such as retinal blood vessels, as the eye moves. In general, image device 126 is any device capable of tracking eye movement. In an embodiment, included as part of image device 126 is a software application (not shown) that determines the actual point of gaze based on the input received from image device 126. In another embodiment, the software application (not shown) may be a stand-alone software program which works in conjunction with image device 126.

In embodiments of the present invention, prevent program 128 may be a program, subprogram of a larger program, application, plurality of applications, or mobile application software which functions to direct keyboard input to a desired location. A program is a sequence of instructions written by a programmer to perform a specific task. Prevent program 128 may run by itself or may be dependent on system software (not shown) to execute. In one embodiment, prevent program 128 functions as a stand-alone program residing on user device 120. In another embodiment, prevent program 128 may be included as a part of an operating system (not shown) of user device 120. In yet another embodiment, prevent program 128 may be integrated into a program which opens a new, active window (e.g., an instant messaging program). In yet another embodiment, prevent program 128 may work in conjunction with other programs, applications, etc., found on user device 120 or in computing environment 100. In yet another embodiment, prevent program 128 may be found on other computing devices (not shown) in computing environment 100 which are interconnected to user device 120 via network 110.

According to embodiments of the present invention, prevent program 128 functions to direct keyboard input to a desired location. According to an embodiment of the present invention, prevent program 128 utilizes the eye gaze of a user of user device 120 to direct input via input device 122 to the desired location of the user.

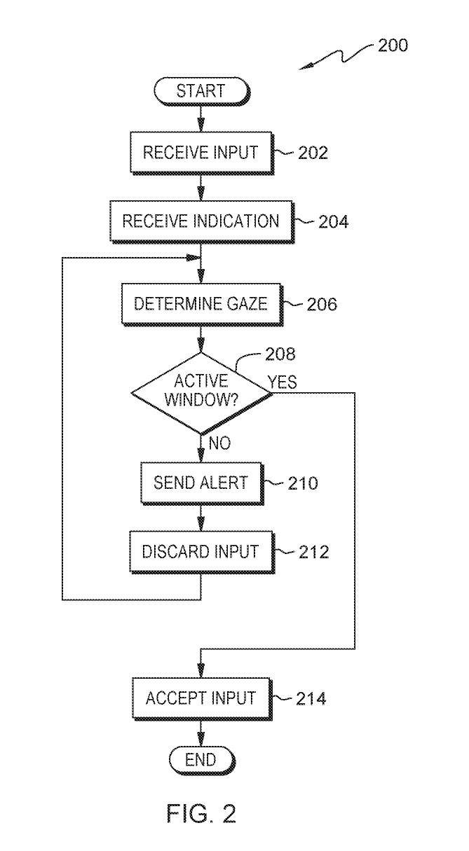

FIG. 2 is a flowchart of workflow 200 representing operational steps for directing keyboard input to a desired location, in accordance with an embodiment of the present invention. In one embodiment, prevent program 128 performs the operational steps of workflow 200. In an alternative embodiment, while working with prevent program 128, any other program may perform the operational steps of workflow 200. In an embodiment, prevent program 128 may invoke the operational steps of workflow 200 when an application executes on user device 120, when an executing application on user device 120 opens a dialogue box, window, or other GUI element, when an executing application on user device 120 causes an opened dialogue box, window or other GUI element to be brought to the foreground of the application, and/or when an executing application on user device 120 causes an opened dialogue box, window, or other GUI element to grab control of user input (i.e., the open dialogue box, window, or other GUI element is active) such that the input provided by the user is directed to that active dialogue box, window, or other GUI element. In an alternative embodiment, prevent program 128 may invoke the operational steps of workflow 200 automatically upon a user turning on user device 120.

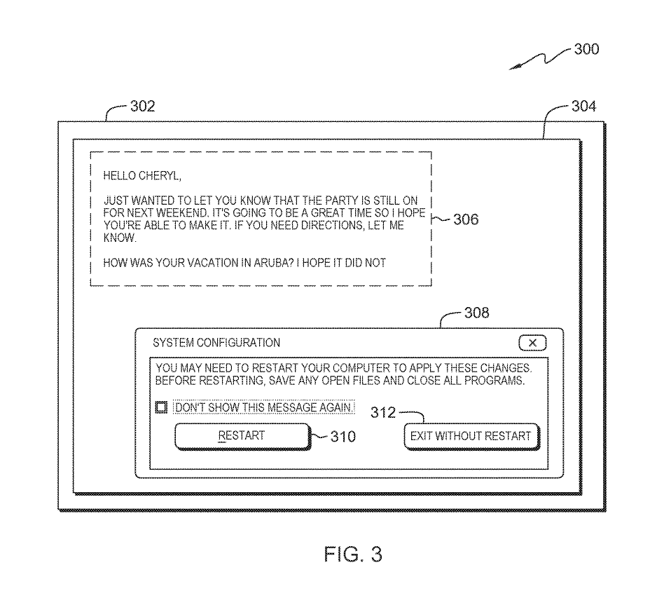

In an embodiment, prevent program 128 receives input (step 202). In other words, prevent program 128 receives input that a user is entering information in an active, first window ‘A’. In an embodiment, a window is a portion of display device 124 that presents its contents (e.g., the contents of a directory, a text file or an image) independently of the rest of display device 124. In an embodiment, prevent program 128 receives input that a user of user device 120 is utilizing input device 122 and the resultant input is shown on display device 124 in first window ‘A’ (not shown). For example, as shown in FIG. 3, ‘Linda’ is typing e-mail 306 to ‘Cheryl’ and e-mail 306 is shown in e-mail window 304 on computer display 302.

In an embodiment, prevent program 128 receives an indication (step 204). In other words, prevent program 128 receives an indication that a second window ‘B’ has opened and that second window ‘B’ is the active window (i.e., user input is directed to second window ‘B’). In an embodiment, prevent program 128 receives an indication that a second window ‘B’ (not shown) is displayed by display device 124 on user device 120 and second window ‘B’ is active. For example, as shown in FIG. 3, system configuration window 308 is displayed in e-mail window 304 on computer display 302 and system configuration window 308 is active (i.e., has taken control of user input). If the next word ‘Linda’ types is “rain”, the letter “r” would activate restart button 310 in system configuration window 308 shown in FIG. 3 and ‘Linda’ would lose e-mail 306. The letter “r” is a shortcut for activating restart button 310 as indicated by the underlined capital R. In another embodiment, prevent program 128 receives an indication that a second window ‘B’, which was already open in display device 124 on user device 120, becomes active. For example, a user may have minimized an instant messaging window while the user types into another window containing a text editor.

In an embodiment, prevent program 128 determines gaze (step 206). In other words, prevent program 128 determines where on the display the user is looking. In an embodiment, prevent program 128 receives data from image device 126 on user device 120 to determine that the user is looking substantially at the upper left quadrant of display device 124. For example, in FIG. 3, ‘Linda’ is looking at e-mail 306 located substantially in the upper left corner of computer display 302.

In an embodiment, prevent program 128 determines whether the gaze of the user is directed at the active window (decision step 208). In other words, prevent program 128 uses the determination of gaze in step 206 to determine if the user is gazing at the active window. In an embodiment, prevent program 128 determines the location of the window or windows on display device 124. In another embodiment, the operating system (not shown) of user device 120 provides the location of the window or windows on display device 124 to prevent program 128. In an embodiment, prevent program 128 links the location of the window or windows on the display to the determined gaze of the user. In an embodiment (decision step 208, YES branch), the user is gazing at the active window; therefore, prevent program 128 proceeds to step 214 to accept the input of the user. Alternatively, in the embodiment (decision step 208, NO branch), the user is not gazing at the active window; therefore, prevent program 128 proceeds to step 210.

In an embodiment, based on the determination that the user is not gazing at the active window (decision step 208, NO branch), prevent program 128 sends an alert (step 210). In other words, prevent program 128, after determining that the user is not looking at active window ‘B’, sends an alert to the user that a second window ‘B’ has opened and is active (i.e., taken control of user input). In an embodiment, the alert may be an audible sound such as a beep. In another embodiment, the alert may be a visual indicator such as a flashing screen border. In yet another embodiment, the alert may be a haptic feedback such as a vibration on an input device. In an embodiment, prevent program 128 sends an alert triggering a flashing screen border of display device 124 on user device 120. For example, the border of computer display 302 in FIG. 3 begins to flash (i.e., blink off and on).

In an embodiment, prevent program 128 discards input (step 212). In other words, after determining that the user is not looking at the active window ‘B’, prevent program 128 discards user input from the point of time that second window ‘B’ opened and became active until a point in time that the gaze of the user is directed to second window ‘B’. In an embodiment, prevent program 128 discards the input the user entered via input device 122 on user device 120. For example, in FIG. 3, the word “rain” and all subsequent entries such as words, punctuation, etc. are discarded and the result is that system configuration window 308 does not recognize an “r” entry. Therefore, restart button 310 is not activated and the computer does not restart causing the loss of e-mail 306. In another embodiment, a user may disregard the sent alert (step 210) which results in the user input being accepted in active window ‘B’. In an embodiment, the alert may be disregarded by the user selecting an icon, by a mouse click in the active window ‘B’ by the user, by a double mouse click by the user, by the user speaking a word or phrase, by a motion by the user, or by any other method known in the art. For example, a minimized instant messaging window may become active and the user may disregard the audible alert so that the input of the user is directed to the instant messaging window.

In an embodiment, based on the determination that the user is gazing at the active window (decision step 208, YES branch), prevent program 128 accepts input (step 214). In other words, after determining that the user is gazing at active second window ‘B’, prevent program 128 accepts user input for active second window ‘B’. In an embodiment, prevent program 128 accepts the input by a user via input device 122 on user device 120. For example, in FIG. 3, ‘Linda’ is able to select exit without restart button 312 in system configuration window 308 and by doing so, does not lose e-mail 306 to an unexpected restart of the computer.

FIG. 4 depicts computer system 400 which is an example of a system that includes prevent program 128. Computer system 400 includes processors 401, cache 403, memory 402, persistent storage 405, communications unit 407, input/output (I/O) interface(s) 406 and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processors 401 by holding recently accessed data, and data near recently accessed data, from memory 402.

Program instructions and data used to practice embodiments of the present invention may be stored in persistent storage 405 and in memory 402 for execution by one or more of the respective processors 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external devices 408 such as a keyboard, keypad, a touch screen, and/or some other suitable input device. External devices 408 can also include portable computer readable storage media such as, for example, thumb drives, portable optical or magnetic disks, and memory cards. Software and data used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for directing a keyboard input to a desired location, the method comprising:
receiving, by one or more computer processors, a first input from a user in a first window, wherein:
the first input of the user is one or more of the following: a typed entry on a keyboard, a typed entry on a touch screen, an audio entry via a microphone, an entry via a mouse, and an entry via a joystick;
the first window is active; and
the first window is a first portion of a display that presents its content independently of a second window that is a second portion of the display;
receiving, by one or more computer processors, an indication that the second window is active and the first window is inactive;
responsive to receiving the indication that the second window is active, directing, by one or more computer processors, the first input received to the second window from a time that the second window became active;
determining, by one or more computer processors, a gaze of the user;
responsive to determining that the gaze of the user is on the second window, accepting, by one or more computer processors, a portion of the first input of the user in the second window from a time that the gaze of the user is on the second window;
responsive to determining that the gaze of the user is not on the second window, sending, by one or more computer processors, an alert to the user that the second window is active, wherein the alert is one or more of the following: an audio alert, a visual alert, and a haptic alert; and
responsive to determining that the gaze of the user is not on the second window, discarding, by one or more computer processors, the first input of the user until the gaze of the user is directed at the second window, wherein the first input of the user is discarded from the time that the second window became active.
